(19) United States
(12) Patent Application Publication
(10) Pub. No.: US 2007/0217702 A1
(43) Pub. Date: Sep. 20, 2007

(54) Method and apparatus for decoding digital video stream

(76) Inventor: Chih-Ta Star Sung, Glonn (DE)

Correspondence Address: Chih-Ta Star SUNG, RM. 308. BLD. 52, NO. 195, CHUNG HSING RD., SEC. 4, CHU TUNG TOWNSHIP, HSINCHU COUNTY, 310, TW

(21) Appl. No.: 11/374,608

(22) Filed: Mar. 14, 2006

(51) Int. Cl. G06K 9/36

(52) U.S. Cl. 382/236

(57) ABSTRACT

The present invention provides method and apparatus of digital video stream decoding by calculating the complexity of the B-type coded frame or macro-block and decoding whether the motion compensation can be skipped to save the time of accessing the referencing memory. The block with the decompressed accumulative pixel difference is less than a predetermined threshold and the motion vector equals to (0,0) or “Frame movement”, the motion compensation is skipped and one of the P-Type or I-type referencing frames will be accessed as the reference for motion compensation.

### BACKGROUND OF THE INVENTION

1. Field of Invention

The present invention relates to digital video decompression, and, more specifically to an efficient video bit stream decoding method and apparatus that results in the saving of computing times of accessing referencing memory.

2. Description of Related Art

ISO and ITU have separately or jointly developed and defined some digital video compression standards including MPEG-1, MPEG-2, MPEG-4, MPEG-7, H.261, H.263 and H.264. The success of development of the video compression standards fuels wide applications which include video telephony, surveillance system, DVD, and digital TV. The advantage of digital image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-frame or P-frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In decompressing the P-type or B-type of video frame or block of pixels, accessing the referencing memory requires a lot of time. Due to IO data pad limitation of most semiconductor memories, accessing the memory and transferring the pixels stored in the memory becomes bottleneck of most implementations.

The method and apparatus of this invention significantly speeds up the procedure of reconstructing the digital video frames of pixels.

### SUMMARY OF THE INVENTION

The present invention is related to a method and apparatus of the video data stream decoding, which speeds up the procedure of reconstructing the digital video with less power consumption. The present invention significantly reduces the computing times compared to its counterparts in the field of video stream decompression.

The present invention of the efficient video bit stream decoding analyzes the complexity and quality of the compressed video stream and decides which frame of pixels can be skipped in decompression.

The present invention of the efficient video bit stream, a hierarchical analysis way is applied to quickly decide whether a By-type frame can be skipped in motion compensation.

According to one embodiment of present invention, B-type frame or block will more likely be skipped than P-type frame or block in video decompression.

According to one embodiment of present invention, when skipping P-type frame or block, lossless image quality of the majority of pixels is required.

According to one embodiment of present invention, prediction mechanism is applied to determine which frame or block can be skipped.

According to one embodiment of present invention, within a macroblock, some blocks can be skipped in video decompression, some can not be skipped.

According to one embodiment of present invention, when skipping is determined, the weighted factors of neighboring frames are updated according to which block is skipped.

According to one embodiment of present invention, there will be no need to accessing the reference frame memory data which block is to be skipped, hence, the memory bandwidth will be available for other unit to access and the decompression engine has more time to work on other operation.

It is to be understood that both the foregoing general description and the following detailed description are by examples, and are intended to provide further explanation of the invention as claimed.

### BRIEF DESCRIPTION OF THE DRAWINGS

FIG. 1 shows three types of motion video coding.

FIG. 2 depicts a block diagram of a video compression procedure with two referencing frames saved in so named referencing frame buffer.

FIG. 3 illustrates the mechanism of motion estimation.

FIG. 4 illustrates a block diagram of decoding a video stream.

FIG. 5A depicts the block diagram of block based motion compensation which depicts the way of recovering block pixels with weighted referencing pixels value of previous and next frame pixels.

FIG. 5B depicts the block diagram of this invention of block based motion compensation of B-type frame/block which depicts the way of recovering block pixels with an updated weighting of 1.0 of only one referencing frame.

FIG. 6 depicts an example of block DCT coefficient comparison between adjacent frames.

FIG. 7 depicts the mode of predicting which block can be skipped in decompressing.

FIG. 8 depicts a procedure of the video decompression with this present invention.

FIG. 9 shows the block diagram of the apparatus of the video decompression with this present invention.

### DESCRIPTION OF THE PREFERRED EMBODIMENTS

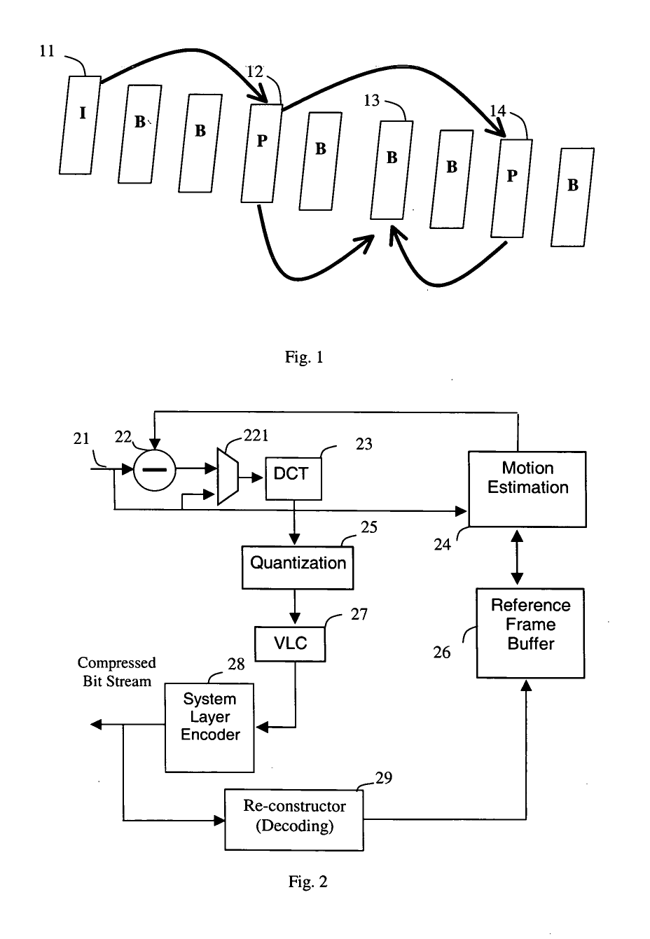

There are essentially three types of picture coding in the MPEG video compression standard as shown in FIG. 1. I-frame 11, the “Intra-coded” picture, uses the block of pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information.

In most applications, since the I-frame does not use any other frame as reference and hence no need of the motion estimation, the image quality is the best of the three types of pictures, and requires least computing power in encoding. The encoding procedure of the I-frame is similar to that of the JPEG picture. Because of the motion estimation needs to be done in referring both previous and next frames, encoding B-type frame consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. In most video compression standard including MPEG, a B-type frame is not allowed for reference by other frame of picture, so, error in B-frame will not be propagated to other frames and allowing bigger error in B-frame is more common than in P-frame or I-frame. Encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

FIG. 2 shows the block diagram of the MPEG video compression procedure, which is most commonly adopted by video compression IC and system suppliers. In I-type frame coding, the MUX 221 selects the coming original pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-type frame or P-type bit stream will then be reconstructed by the reverse route of decompression procedure 29 and be stored in a reference frame buffer 26 as future frames' reference. In the case of compressing a P-frame, B-frame or a P-type, or a B-type macro block, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame. The block difference is then fed into the DCT 23, quantization 25, and VLC 27 coding, which is the same procedure like the I-frame coding.

In the encoding of the differences between frames, the first step is to find the difference of the targeted frame, followed by the coding of the difference. For some considerations including accuracy, performance, and coding efficiency, in some video compression standards, a frame is partitioned into macroblocks of 16×16 pixels to estimate the block difference and the block movement. Each macroblock within a frame has to find the “best match” macroblock in the previous frame or in the next frame. The mechanism of identifying the best match macroblock is called “Motion Estimation”.

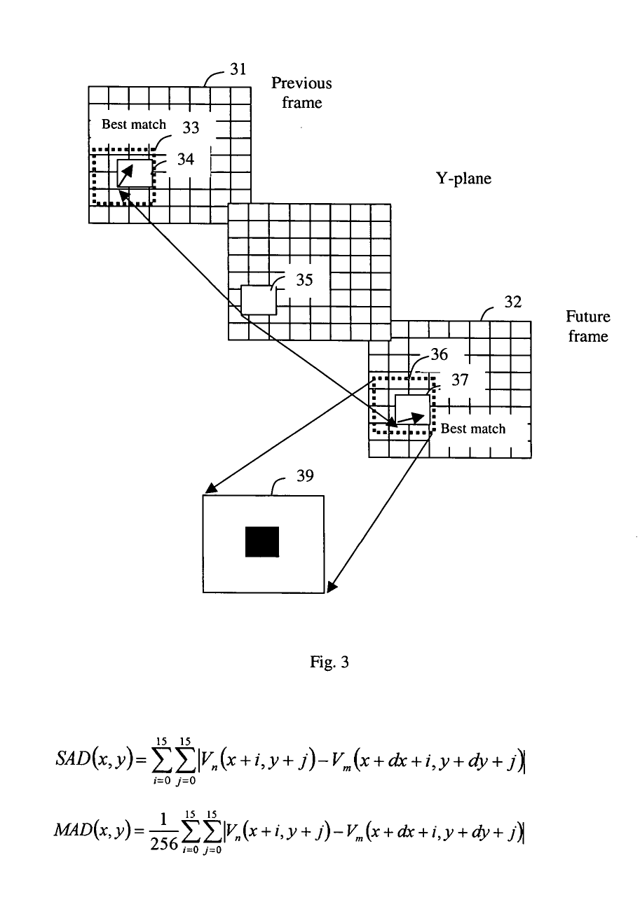

Practically, a block of pixels will not move too far away from the original position in a previous frame, therefore, searching for the best match block within an unlimited range of region is very time consuming and unnecessary. A limited searching range is commonly defined to limit the computing times in the “best match” block searching. The computing power hungered motion estimation is adopted to search for the “Best Match” candidates within a searching range for each macro block as described in FIG. 3. According to the MPEG standard, a “macro block” is composed of four 8×8 “blocks” of “Luma (Y)” and one, two, or four “Chroma (2 Cb and 2 Cr)”. Since Luma and Chroma are closely associated, in the motion estimation, only Luma motion estimation is needed, and the Chroma, Cb and Cr in the corresponding position copy the same MV of Luma. The Motion Vector, MV, represents the direction and displacement of the block movement. For example, an MV=(5, −3) stands for the block movement of 5 pixels right in X-axis and 3 pixel down in the Y-axis. Motion estimator searches for the best match macroblock within a predetermined searching range 33, 36. By comparing the mean absolute differences, MAD or sum of absolute differences, SAD, the macroblock with the least MAD or SAD is identified as the “best match” macroblock. Once the best match blocks are identified, the MV between the targeted block 35 and the best match blocks 34, 37 can be calculated and the differences between each block within a macro block are encoded accordingly. This kind of block difference coding technique is called “Motion Compensation”.

The Best Match Algorithm, BMA, is the most commonly used motion estimation algorithm in the popular video compression standards like MPEG and H.26x. In most video compression systems, motion estimation consumes high computing power ranging from ˜50% to ˜80% of the total computing power for the video compression. In the search for the best match macroblock, a searching range, for example +/−16 pixels in both X- and Y-axis, is most commonly defined. The mean absolute difference, MAD or sum of absolute difference, SAD as shown below, is calculated for each position of a macroblock within the predetermined searching range, for example, a +/−16 pixels of the X-axis

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

and Y-axis. In above MAD and SAD equations, the Vn and Vm stand for the 16×16 pixel array, i and j stand for the 16 pixels of the X-axis and Y-axis separately, while the dx and dy are the change of position of the macroblock. The macroblock with the least MAD (or SAD) is from the BMA definition named the “Best match” macroblock. The calculation of the motion estimation consumes most computing power in most video compression systems.

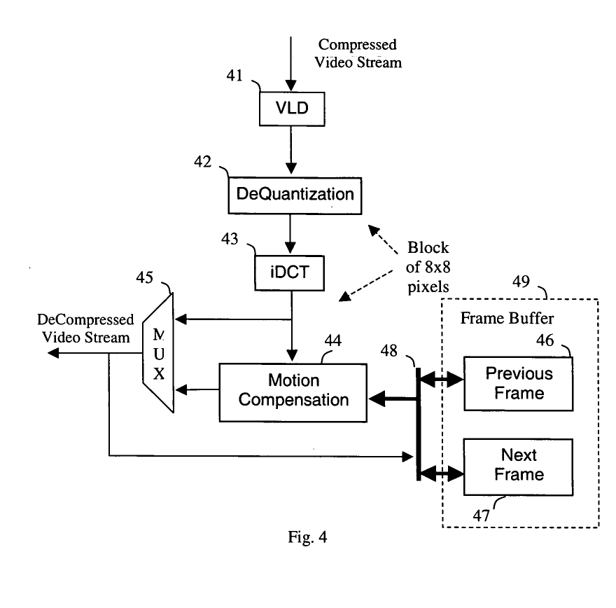

FIG. 4 illustrates the procedure of the MPEG video decompression. The compressed video stream with system header having many system level information including resolution, frame rate, . . . etc. is decoded by the system decoder and sent to the VLD 41, the variable length decoder. The decoded block of DCT coefficients is shifted by the “Dequantization” 42 before they go through the inverse DCT, iDCT 43 and recover time domain pixel information. In decoding the non intra-frame, including P-type and B-type frames, the output of the iDCT are the difference between the current frame and the referencing frame and should go through motion compensation 44 to recover to be the original pixels. The decoded I-frame or P-frame can be temporarily saved in the frame buffer 49 comprising the previous frame 46 and the next frame 47 to be reference of the next P-type to B-type frame. When decompressing the next P-type frame or next B-type frame, the memory controller will access the frame buffer and transfer some blocks of pixels of previous frame and/or next frame to the current frame for motion compensation. Transferring block pixels to and from the frame buffer consumes a lot of time and I/O bandwidth of the memory or other storage device.

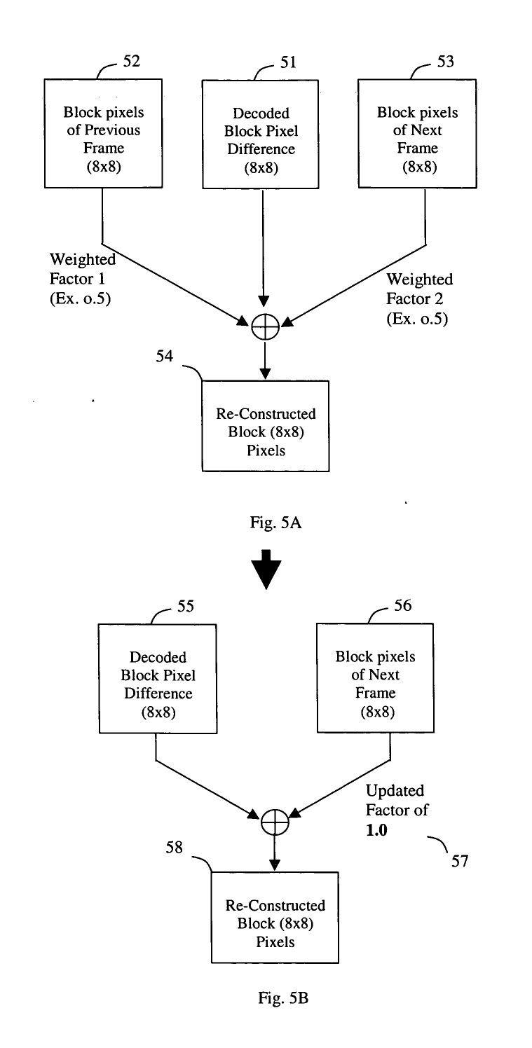

FIG. 5A shows the motion compensation of one block pixels within a B-type frame. The reference block pixels of previous frame 52 and next frame 53 times the corresponding weighted factor are added to the decoded block of pixel difference 51 to reconstruct a B-type block of pixels 54. FIG. 5B illustrates one of the concepts of this invention of decompressing some B-type frame or macro-block, one of the referencing frames will be skipped, and only one reference frame 56 is selected for motion compensation and the updated weighted factor 57 is rounded to be 1.0 to reconstruct the block pixels 58 with the decoded block 55 of pixel differences. In some alternatives, including H.264, one of the latest MPEG video compression standard uses multiple frames as references for motion compensation, this invention also applies to those video compression decompression with multiple frames as reference by skipping at least one frame and using one as the reference to minimize the I/O bandwidth requirement of accessing the storage device.

Since B-type frame will need to access referencing pixels of previous frame and next frame which requires high memory I/O bandwidth, one of the method of this invention of decoding the video stream is to analyze the complexity of the image of the B-type frame, if not much difference between the two referencing frames, the corresponding B-type frame will be skipped and use the nearest referencing frame to represent it instead. Some video streams having same displacement of most pixels caused by vibration or movement of the image capturing device video recorder. Even most blocks with a B-type frame have displacement of non “0”, the B-type frame video decoding procedure can also be skipped and the nearest neighbor frame is used to represent the skipped B-type frame.

In some video standard including MPEG, there are efficient methods of P-type and B-type frame compression. For instance, the “Skip Macro-block” or named “Skip MB” in MPEG video compression standard, when an encoder can assign a code of “Skip Macro-block”. A macro-block in MPEG comprised of 4 Y blocks and another 1 or 2 Cb and Cr blocks with each block having 8×8 pixels. The requirement of applying “Skip MB” code includes

1. All 4 Y blocks having same motion vector of (0,0): this means no movement

2. All DCT coefficients of all 4Y and Cb Cr blocks are “0”: standing for no change of content with all pixels within a macro-block.

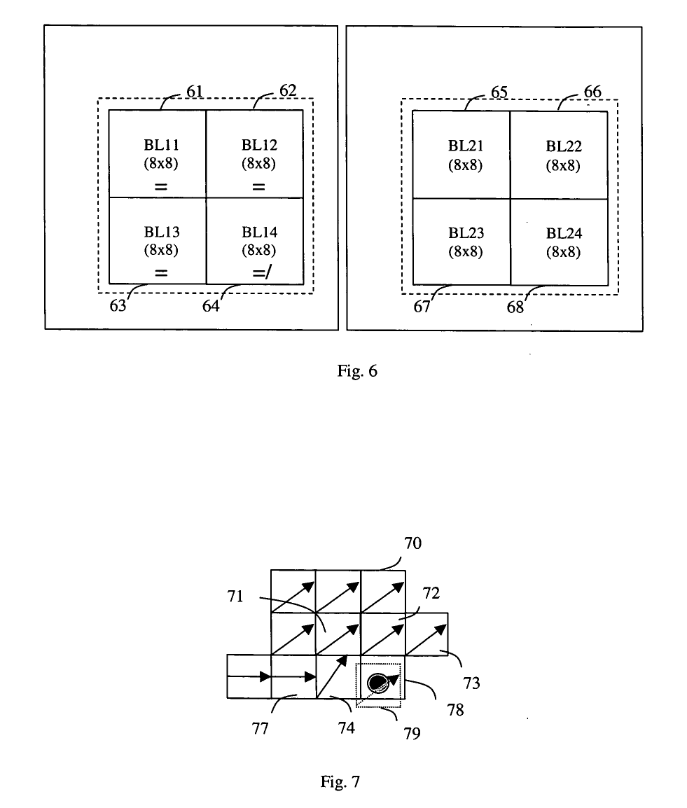

As illustrated in FIG. 6, the motion vectors of all 4 Y blocks should be (0,0) and all pixel within the 4 Y blocks 61, 62, 63, 64 and Cb and Cr blocks should be equal to those corresponding pixels 65, 66, 67, 68 in the neighboring frame. Even five blocks are equal, only one pixel within a block is not equal, the “Skip MB” code can not be applied in coding the macro-block.

This invention of the video decompression accesses only blocks pixels within a macro-block which are not equal to the corresponding block of the neighboring frame. Those blocks with DCT coefficients of all “0s” access only those blocks in one instead of two neighboring frame. Another key of the invention of the video decompression is those macro-blocks with none (0,0) MVs and can not apply “Skip MB” code due to frame movement can still be skipped if the DCT coefficients are minimum values. The Cb and Cr have higher probability of being all 0s than Y block and can more frequently being skipped one neighboring frame. To add the pixels of only one neighboring frame, the weighted factor in the original video stream should be updated to be “1” from 0.5/0.5 (if one B-type frame between 2 P-type or I-type frames) or 0.33/0.67 (if two B-type frame between 2 P-type or I-type frames). Accessing only one neighboring frame for compensation in B-type frame saves 50% of time and hence the I/O bandwidth of the storage device of the referencing buffer.

Some blocks and even macro-blocks move with the same motion vectors and one method of the is invention of the video decompression is to predict which blocks or macro-blocks have high probability of having same MV and all DCT coefficients are 0s, and the procedure of video block decompression can even be skipped and only access one neighboring frame. FIG. 7 illustrates the principle of predicting the MV pf neighboring macro-blocks or blocks. A block 78 of pixels are surrounded by neighboring blocks 71, 72, 73, 74 including upper blocks and left block and the corresponding block of previous frame 79. Most movement have high consistency and can be prediction by examining further blocks 70, 77. Block decompression procedure also dominates high percentage of computing power which can be waived is high accuracy in prediction of which block can be skipped.

For further reduce the time of accessing the referencing frame buffer when decompressing a B-type frame, this invention decodes the two block pixels difference plan of the two neighboring frames, the block of the frame with smaller difference will be selected to represent the pixels difference plan and the block pixels of the corresponding referencing frame will be accessed for motion compensation.

In some applications, many B-type frames can be skipped without degrading much the image quality. The decision of skipping B-type frame can be done by comparing the factor that the sum of difference between two P-type (or I-type and P-type) frames is smaller than a predetermined threshold. For quickly determine whether and which B-type frame can be skipped, a calculation of selecting some macro-blocks from variable locations of an image can decide the error with and without decoding the B-type frame. This method can also be done by a hierarchical way by firstly calculating the error between skipping and non-skipping, after identifying the location of higher error, more blocks of pixels are calculated in the second level of error estimation. For example, a B-type picture can be partition to be 4 quadrants with each having video stream of 32 macro-blocks to be decoded and calculated the error. The quadrant(s) with higher than a predetermined threshold will go through a second round of error estimation with another said 16 macro-blocks of each quadrant within it and to decide which quadrant(s) has high error.

It is very common that the frame has moving due to vibration or intentional moving of video recorder. In both cases, all macro-blocks within a frame will have the same frame motion vector, or called FMV. In skipping motion compensation of accessing referencing frames, one can copy blocks of the previous or next frame pixels of the corresponding frame motion vector to represent the blocks skipping motion compensation. It is also very common that a group of blocks of pixels are moving at the same motion direction and displacement which result in the same motion vector and some blocks not by the edge of an object can skip motion compensation of accessing two referencing frames but copying the corresponding blocks of pixels to represent the current block pixels.

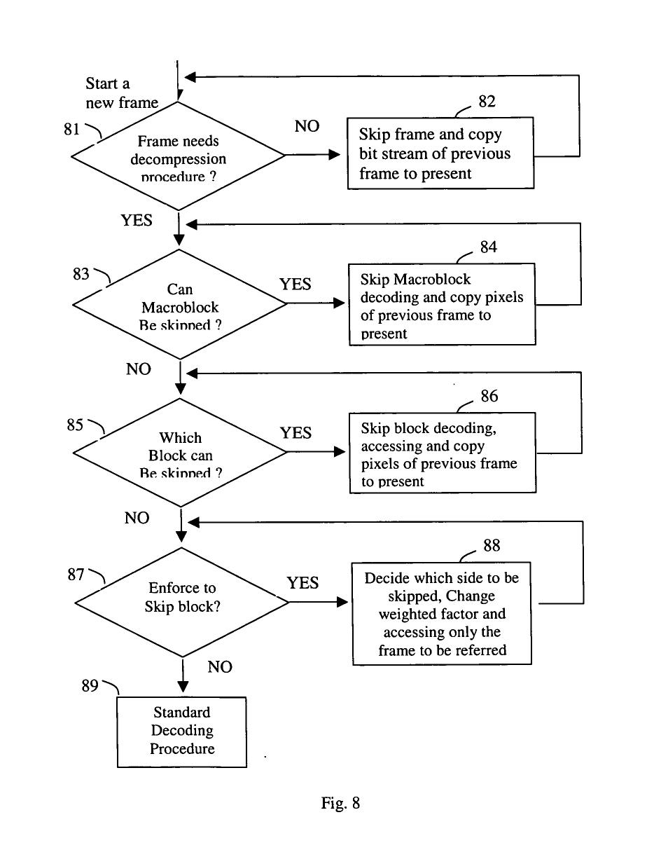

FIG. 8 is a flowchart summarizing this invention of decompressing the video stream. A B-type can be skipped 81 without decoding it and a previous or next P-type or I-type frame is copied 82 to represent it. In the next level of Macro-block 83, some methods are described above paragraphs which can be applied to decide whether a macro-block decoding procedure can be waived. If YES, the corresponding macro-block 84 of previous frame is copied to represent it. Similar to the macro-block level, the block level 85 of pixel decoding can also be considered of being skipped and previous frame blocks 86 are used to replace the B-type blocks. In case of enforcing skipping 87, a decision of which side of image to be skipped and changing the weighted factor 88 of the surviving picture is expected accordingly. The last choice of going through standard decompression procedure 89 will be enforced afterward trying all these proposed method of block skipping.

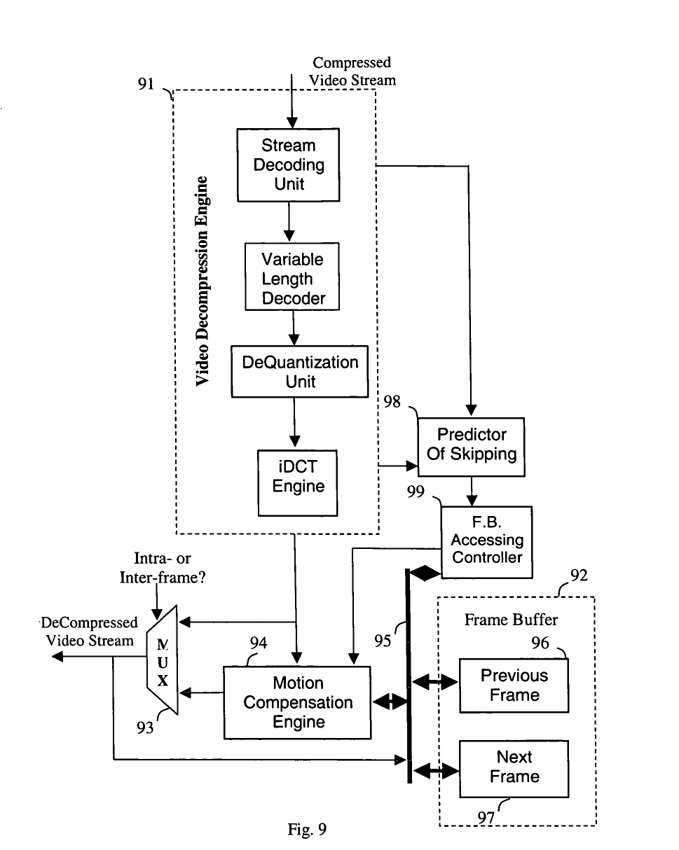

FIG. 9 shows the block diagram of the apparatus of this invention. The coming vide stream is decoded by a stream parser which is a part of the video decompression engine 91. The video decompression engine is comprised of the stream decoder, a variable length decoder, a de-quantization unit which times the VLD decoded DCT coefficients with a table which is recovered by decoding the video stream in the stream decoding unit. The de-quantized DCT coefficients will be transformed from the frequency domain back to the time domain pixel data through the iDCT, the inversed DCT engine. In Intra-coded 93 frame or macro-block, the output of the iDCT can be the output of the decompression. In Inter-code mode, the iDCT output will input to the motion compensation engine to reconstruct the pixel by adding the referencing block pixels stored in the referencing frame buffer 92. In P-type coding, it needs only previous frame 96 as the referencing frame, in B-type coding, if following standard decompression procedure, both previous frame and next frame 97 are needed for motion compensation. In this invention, most macro-blocks need only one referencing frame, either previous frame or next frame will be referred for motion compensation. A predictor of skipping 98 is coupled between the video decompression engine 91 and the frame buffer accessing controller 99 to decode whether and which frame, macro-block or block of pixels can be skipped.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method for decoding a video stream, comprising:
Decompressing video stream data and storing the reconstructed P-type or I-type frame or macro-block into a temporary storage device;
Decompressing the bit stream of a B-type frame or macro-block without motion compensation yet;
Calculating the accumulative decompressed pixel differences of individual block and comparing the motion vector of a macro-block;
Skipping motion compensation of accessing at least one referencing memory for those blocks with accumulated pixels differences less than a predetermined threshold and motion vector of (0,0) or frame motion vector; and
Accessing the corresponding frame or block pixels stored in the selected referencing frame to represent the current B-type frame or block or for motion compensation to reconstruct the current block pixels.

2. The method of claim 1, further comprising steps of predicting which macro-block with B-type coding can skip the motion compensation.

3. The method of claim 2, further comprising the step of calculating the accumulative pixels difference of neighboring macro-blocks and deciding whether or not the current macro-block can skip the motion compensation.

4. The method of claim 1, further comprising the step of calculating the accumulative pixels difference of blocks within a macro-block and deciding which block can skip the motion compensation and accessing block pixels of one selected referencing frame.

5. The method of claim 1, further comprising the decision making procedure of skipping motion compensation for blocks with motion vector of (0,0) or same with frame motion vector if the accumulative differential values is less than the predetermined threshold.

6. The method of claim 1, wherein a procedure of deciding which blocks within an object can skip motion compensation.

7. The method of claim 1, wherein the decompressed pixel includes Luma of brightness and Chroma of U and V elements.

8. A method for decoding a video frame, comprising:
Decompressing a video stream data and storing the reconstructed P-type or I-type frame or macro-block into a temporary storage device;
Decompressing the bit stream of a B-type coded frame without motion compensation yet;
In parallel, calculating the value of the accumulative error between skipping and non-skipping motion compensation with at least two macro-blocks within at least two quadrants of an image; and
Skipping the procedure of motion compensation of the current B-type frame should the predicted accumulative error between skipping and non-skipping motion compensation is below a predetermined threshold.

9. The method of claim 8, wherein the referencing frame with less accumulative decompressed pixel differences of selected blocks is selected to represent the current B-type frame.

10. The method of claim 8, wherein a referencing image is divided to be four quadrants and at least one macro-block in each quadrant is selected in calculating the accumulative error of motion compensation with referring to one or both referencing frames.

11. The method of claim 8, wherein the quadrant with accumulative error higher than another predetermined threshold is examined further by selecting at least two macro-blocks.

12. The method of claim 8, wherein the macro-block is comprised of N×M pixels with N and M integer number.

13. An apparatus for decoding a video stream, comprising:
a video decompression engine decoding video stream and reconstructing video frame one by one;
a storage device for storing at least one decompressed video frame as reference for other neighboring frame;
a motion compensation unit for adding the decompressed pixel difference to the referencing frame or block to reconstruct a complete block of pixels.
predicting unit for determining whether motion compensation of the current B-type coded frame or macro-block can be skipped and selects the right frame as reference in motion compensation; and
a device controlling the data access to and from the selected referencing frames.

14. The apparatus of claim 13, wherein the motion compensation unit add the pixel difference of a decoded block to one selected block of one neighboring frames in the referencing frame buffer to reconstruct a block of pixels.

15. The apparatus of claim 13, wherein the video decoder is comprised at least a variable length decoder, a DeQuantizer and an inverse DCT calculation engine.

16. The apparatus of claim 13, wherein the motion compensation unit add the pixel difference of a decoded block to one selected block of one neighboring frames in the referencing frame buffer to reconstruct a block of pixels.

17. The apparatus of claim 16, wherein the motion compensation unit adjusts the weighted factor of the block pixels of the selected frame to be “1” and add to the pixel difference of the decoded block of pixels.

18. The apparatus of claim 13, wherein the prediction unit calculates the pixel difference of each block and the motion vector of a macro-block and determines whether and which block motion compensation can be skipped by referring only to one referencing frame.

19. The apparatus of claim 13, wherein the prediction unit calculates the complexity of a predetermined number of blocks from variable location of an B-type frame and decides whether the motion estimation for the whole B-type frame can be skipped.
